(19) United States
(12) Patent Application Publication
(10) Pub. No.: US 2008/0066585 A1
(43) Pub. Date: Mar. 20, 2008

(54) SINGLE-DIRECTION OPERABLE OPEN-END SPANNER

(76) Inventor: Ching-An CHIANG, Taichung Hsien (TW)

Correspondence Address: LEONG C LEI, PMB # 1008, 1867 YGNACIO VALLEY ROAD, WALNUT CREEK, CA, 94598, US

(21) Appl. No.: 11/627,989

(22) Filed: Jan. 29, 2007

(30) Foreign Application Priority Data
Sep. 8, 2006 (TW) 095216145

(51) Int. Cl. B25B 13/00

(52) U.S. Cl. 81/125.1

(57) ABSTRACT

A single-direction operable open-end spanner includes a handle having an open end delimited by opposite jaws. One of the jaws forms a cavity delimited by a curved internal wall to receive a movable jaw block. The block is biased by a spring so that when the spanner applies a torque to tighten a threaded member; the jaw block is pushed against the internal wall by a reaction force from the threaded member to ensure proper and sound engagement between the jaw block and the treaded member. When the spanner is rotated in a reversed direction to loosen the threaded member, the jaw block is driven in a direction against the spring and away from the threaded member to form an enlarged clearance between the jaw block and threaded member to allow the jaws to slide over the side faces of the threaded member.

### BACKGROUND OF THE INVENTION

(a) Technical Field of the Invention

The present invention relates to the field of hand tools, and in particular to an open-end spanner that can be operated in a single direction.

(b) Description of the Prior Art

A bolt and a nut are often used in pair to secure and/or release an object by threading engagement therebetween that is secured by rotating either one of the bold or nut with respect to the other. The threading engagement between two mated threaded members is often effected by a hand tool or a power tool. A common hand tool for this purpose is an open-end spanner that has an open end to receive and engage a nut or a head of a bolt. The spanner has an elongate handle that allows a user to apply a torque to rotate the threaded members with respect to each other. However, due to the physical limitation of the human body or due to the constrain against full turn rotation imposed by a limited space in which the threaded member are installed, the hand tool must be separated from the threaded member after rotation of a predetermined angular displacement and be positioned back to the original angular position for repeating the next rotation of approximately the same angular displacement. This is a very troublesome and time-consuming operation.

A ratchet wrench is available in the market, which allows for applying torque to and thus rotation of a threaded member in a single direction and load-free retraction in an opposite direction. The single direction operation is realized by a ratchet wheel and a pawl that is selectively put into driving engagement with the ratchet to effect the single-direction operation. The ratchet and pawl pair inevitably complicates the overall structure of the wrench, which in turn increases costs of manufacturing and difficulty in assembling. In addition, mechanical strength is not always ensured for the engagement between the pawl and the ratchet, which leads to constrains on the torque applied to the threaded member through the wrench. Further, the pawl and the ratchet occupy a substantial amount of space, which makes the overall size of the wrench inappropriate for operation in a very limited space.

A ratchet type open-end spanner is also available in the market, which has opposite ends both forming an open end for receiving a threaded member in a loose fit manner. Application of torque through the loose fit engagement between the spanner and the threaded member can then be effected to tighten/loosen the threaded member. However, the spanner must be separated from the threaded member after rotation of a predetermined angular displacement and re-fit over the threaded member for the next rotation of the angular displacement. This is similarly a troublesome operation to the general consumers. In addition, the spanner is incapable to operate in a limited space.

Thus, it is desired to have an open-end spanner that can be operated in a single direction to ensure operation efficiency.

### SUMMARY OF THE INVENTION

The primary purpose of the present invention is to provide a single-direction operable open-end spanner that has a simple structure, is easy to operate ness, and has low costs of manufacturing.

To achieve the above object, the present invention provides a single-direction operable open-end spanner comprising a handle having an open end delimited by first and second jaws opposite to and spaced from each other. The first jaw has an inner edge opposing the second jaw and forming a curved cavity in which a movable jaw block is movably received and biased against an internal wall of the cavity by a spring arranged between the movable jaw block and an inner bottom end of the cavity. A lid is mounted to the first jaw to retain the movable jaw block in the cavity.

Such an arrangement of spanner in accordance with the present invention apparently simplifies the overall structure of the spanner whereby manufacturing can be simple and difficulty of assembling alleviated. Further, torque applied through the spanner can be increased without undesirably damage the spanner and operation of the spanner within a limited space is allowed. Conclusively, a spanner that is enhanced in both market value and operation efficiency is obtained with the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view showing an open end of an open-end spanner constructed in accordance with the present invention;

FIG. 2 is an exploded view of the open-end spanner illustrated in FIG. 1;

FIG. 3 is a plan view of the open-end spanner of the present invention;

FIG. 4 is a plan view of the open end of the spanner of the present invention, illustrating the spanner is rotated in a forward direction to tighten a threaded member;

FIG. 5 is a plan view similar to FIG. 4 but illustrating the spanner is rotated in a backward direction in a retracted and load-free condition; and

FIG. 6 is similar to FIG. 5 but illustrating movement of a movable jaw block of the spanner in a direction to allow load-free backward rotation of the spanner.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

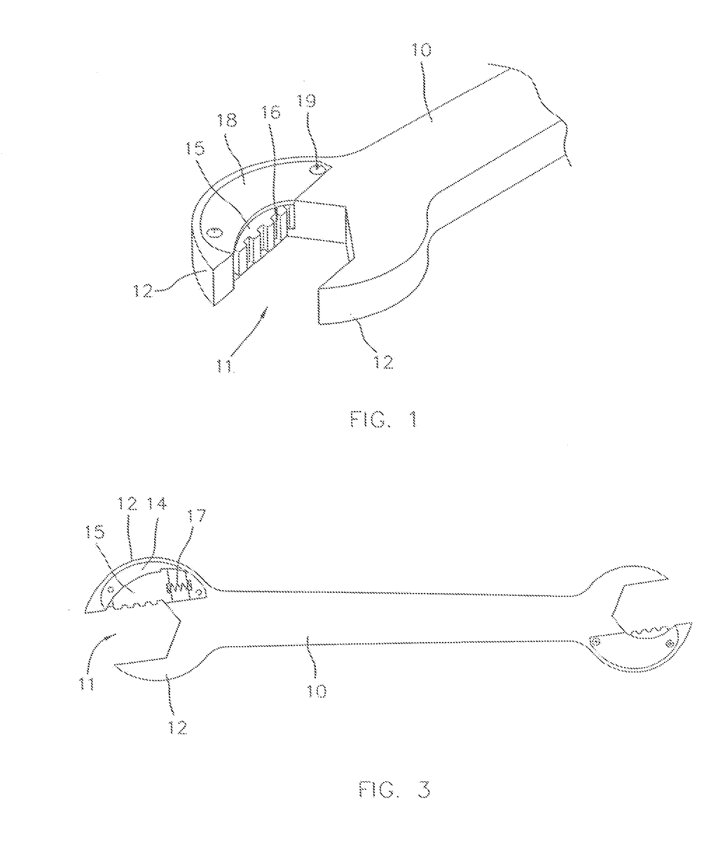

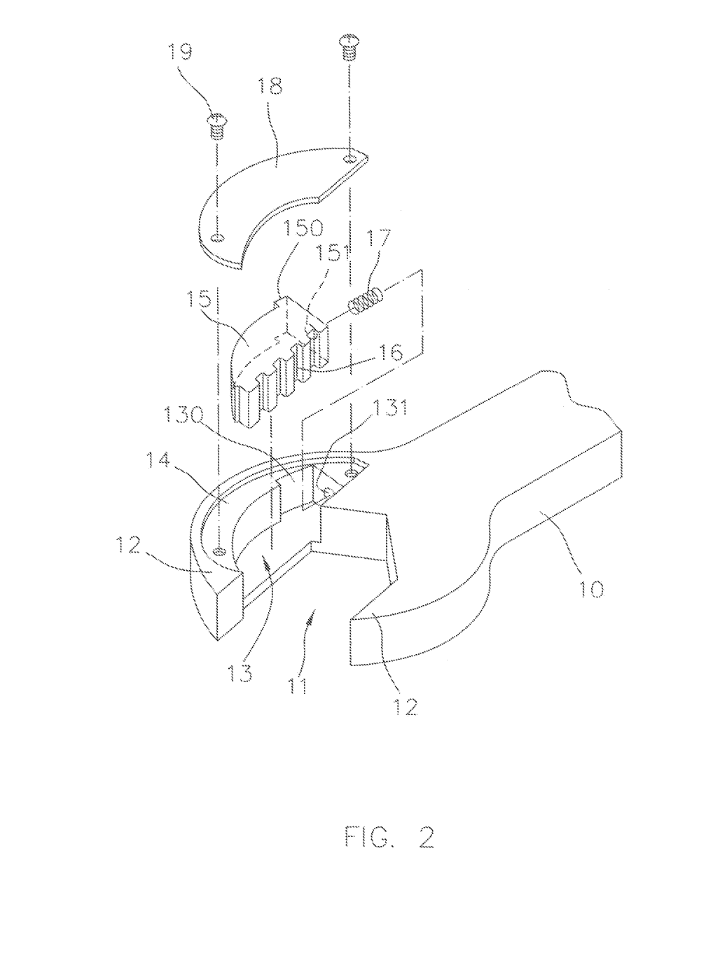

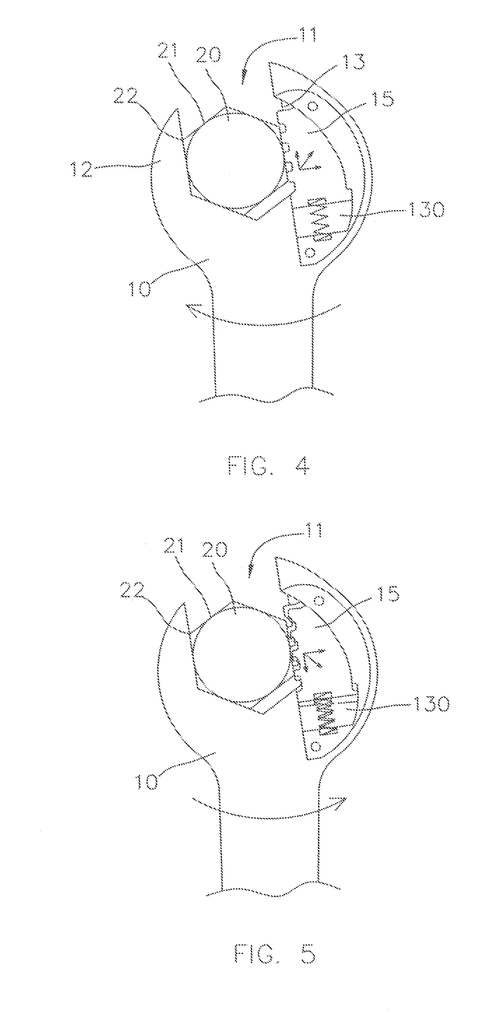

With reference to the drawings and in particular to FIGS. 1 and 2, an open-end spanner constructed in accordance with the present invention comprises a handle 10 having opposite ends of which at least one forms an open end 11 delimited by a pair of spaced and opposing jaws 12. One of the jaws 12 comprises a movable serrated jaw block 15 that faces and cooperates the other jaw 12 to clamp for example a polygonal threaded member 20, as shown in FIG. 4.

Also referring to FIG. 3, the jaw 12 that comprises the jaw block 15 has an inner edge facing the other jaw and forming a curved and recessed cavity 13 in which the movable jaw block 15 is received. The cavity 13 has an internal wall away from the other jaw 12 and a slide channel 130 is defined in the internal wall at a location adjacent to an inner bottom end of the cavity 13 that is close to the handle 10 and the slide channel 130 is in communication with the cavity 13. A receiving hole 131 is defined in the inner bottom end of the cavity 13 that is closed to the adjacent to the handle 10. A stepped flange 14 is formed in one major surface of the jaw 12 and is recessed with respect to the cavity 13 so as to have a cross-sectional dimension greater than that of the cavity 13, whereby a lid 18 can be positioned on and fixed to the stepped flange 14 with bolts 19 to cover the cavity 13 and to protect and retain the movable jaw block 15.

The movable jaw block 15, which is received in the cavity 13 defined in the jaw 12, has an inner back edge forming an extended stop 150 at a lower position adjacent to an inner bottom end of the movable jaw block 15 and corresponding to and received in the slide channel 130 of the cavity 13 so as to define a stroke for the sliding movement of the movable jaw block 15 and to retain the movable jaw block 15. The inner bottom end of the movable block 15 forms a receiving hole 151 that opposes the receiving hole 131 of the cavity 13 for retaining a spring 17 between movable jaw block 15 and the inner bottom end of the cavity 13 to bias the movable jaw block 15 against a top end of the cavity 13 for carrying out clamping of the threaded member 20. The movable jaw block 15 forms a series of engaging slits 16 in the surface opposing the other jaw 12 for increasing friction of the movable jaw block 15 with respect to side faces 21 of the threaded member 20 and to allow easy retraction of the movable jaw block 15.

With the above discussed structure, a single-direction operable open-end spanner that is easy to manufacture with low costs is provided.

Also referring to FIGS. 4-6, the operation of the spanner of the present invention will be discussed. As shown in FIG. 4, when a user attempts to tighten or loosen a threaded member 20 with the open-end spanner of the present invention, the user fits the open end 11 of the spanner over the threaded member 20 with the movable jaw block 15 and the opposing jaw 12 engaging the side faces 21 of the threaded member 20 in an opposite-to-each-other manner and thus clamping the threaded member 20. By applying a torque to the handle 10 for rotating the spanner to effect tightening of the threaded member 20, a reaction force is induced on the movable jaw block 15 by the threaded member 20, including a component in a direction toward the open end and an inward-directed component, which, in combination, provide an inclined and internal-wall-pointing force to forcibly abut the movable jaw block 5 tightly against the internal wall of the cavity 13, whereby the movable jaw block 15 is held securely in position opposite to the and thus cooperating the opposing jaw 12 to securely clamp and rotate the threaded member 20 with the rotation of the handle 10 to thereby tighten the threaded member 20.

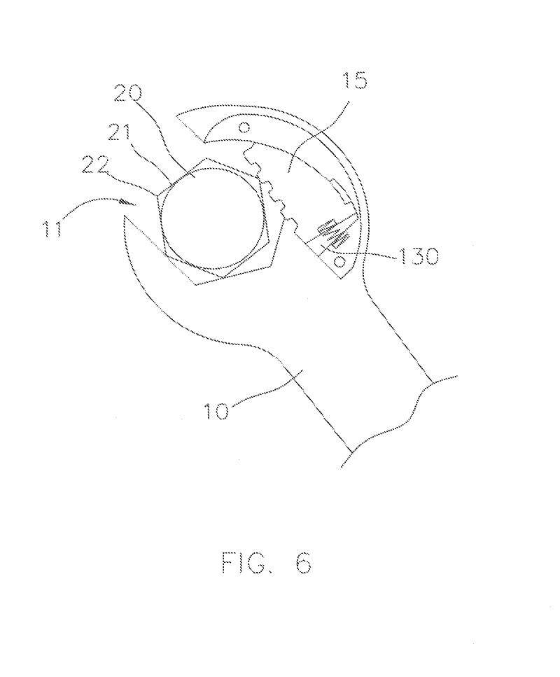

On the other hand, to effect load-free backward rotation, as shown in FIG. 5, the handle 10 is rotated in a reversed direction and a reaction force is inducted on the movable jaw block 15 by the threaded member 20 that is sandwiched between the movable jaw block 15 and the opposing jaw 12 so as to generate a force component directing toward the handle 10 and an inward-directed component to thereby provide, in combination, a force pointing toward the slide channel 130, which causes the movable jaw block 15 to slide along the curved internal wall of the cavity 13 in a direction toward the handle 10 (or the inner bottom end of cavity 13), as shown in FIG. 5.

As shown in FIG. 6, due to the curved configuration of the cavity 13, the sliding of the movable jaw block 15 toward the inner bottom end of the cavity 13 brings the top end of the movable jaw block 15 away from the inner edge of the jaw 12 that forms the cavity 13 and partially retract the movable jaw block 15 back into the cavity 13 so that the distance between the movable jaw block 15 and the opposing jaw 12 is increased to exceed the fixed spacing between the two jaws, namely the distance between the inner edges of the jaws 12. Additional space clearance is thus established between the movable jaw block 15 and the corresponding side face 21 of the threaded member 20. Such an additional space or clearance allows the spanner to rotate with respect to the threaded member 20 in a backward or reversed direction. Thus, backward rotation of the spanner 10 in a load-free condition (namely, the threaded member 20 retains standstill and imposes to load to the backward rotation of the spanner) is effected, which allows the user to bring the spanner back to the original angular position for easy application of torque to the spanner and the threaded member 20. As a consequence, efficient operation of the spanner for tightening or loosening the threaded member 20 can be realized.

Apparently, the spanner of the present invention is advantageous over the prior art spanners by the following facts:

(1) The spanner of the present invention has a simple structure, which simplifies the manufacturing thereof and reduces troubles of assembling. Further, the present invention is applicable by directly machining the existing spanner without preparing new molds.

(2) The engaging slits 16 formed in the movable jaw block 15 can effectively eliminate skidding between the open end 11 of the spanner and the threaded member 20, which protects the threaded member 20 and definitely extend the life span of the threaded member 20.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A single-direction operable open-end spanner comprising a handle having an open end delimited by first and second jaws opposite to and spaced from each other, the first jaw having an inner edge opposing the second jaw and forming a curved cavity in which a movable jaw block is movably received and biased against an internal wall of the cavity by a spring arranged between the movable jaw block and an inner bottom end of the cavity, a lid being mounted to the first jaw to retain the movable jaw block in the cavity.

2. The single-direction operable open-end spanner as claimed in claim 1, wherein the movable jaw block has a surface opposing the second jaw and forming a plurality of engaging slits therein adapted to induce an increased friction with a threaded member received in the open end of the spanner.

3. The single-direction operable open-end spanner as claimed in claim 1 or 2, wherein the inner bottom end of the cavity forms a receiving hole and wherein the movable jaw block forms a corresponding receiving hole, the spring being received in and retained by the receiving holes.

4. The single-direction operable open-end spanner as claimed in claim 1 or 2, wherein a sliding channel is defined in the internal wall of the cavity at a location adjacent to the inner bottom end of cavity and wherein the movable jaw block forms an extended stop slidably received in the sliding channel.

5. The single-direction operable open-end spanner as claimed in claim 1 or 2, wherein the spanner has a major surface in which a stepped flange is formed for receiving and retaining the lid with fasteners.
